(19) United States
(12) Patent Application Publication
(10) Pub. No.: US 2026/0119494 A1
(43) Pub. Date: Apr. 30, 2026

(54) DATA LINKING FRAMEWORK

(71) Applicant: SAP SE, Walldorf (DE)

(72) Inventors: Neha GARG, Bangalore (IN); Bianca DAVID, La Prairie (CA); Alexandre DORAIS, Laval (CA)

(21) Appl. No.: 18/931,546

(22) Filed: Oct. 30, 2024

(51) Int. Cl. G06F 16/2453

(52) U.S. Cl. CPC G06F 16/24544; G06F 16/24537

(57) ABSTRACT

According to some embodiments, systems and methods are provided including a memory storing program code; and one or more processing units to execute the program code to cause the system to: receive a first table name, wherein the first table name represents a first table including one or more first fields; receive a second table name, wherein the second table name represents a second table including one or more second fields; receive one or more join options for at least one of the first table and the second table; receive a join condition for at least one first field and at least one second field; generate a join definition based on the received first table name, the received second table name, the received one or more join options and the received join condition; and execute the join definition. Numerous other aspects are provided.

### BACKGROUND

Organizations produce large amounts of data that is often stored in database tables. Reports are generated to analyze the data. An end user may have a question for which no report exists, and a report is created including data to address their question. While the end user analyzing the report has functional expertise of the data in the database tables and knows the data they want to analyze for a given scenario, the end user often does not have the coding knowledge or the database knowledge (e.g., which tables to access, which data to combine, etc.) to create the report. The user then needs to request the generation of a report from a report creation specialist.

Systems and methods are desired to make it easier for end users to access the data they need without having coding or database knowledge.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a block diagram of an architecture according to some embodiments.

FIG. 2 is a flow diagram of a process according to some embodiments.

FIG. 3 is a user interface including a primary table JOIN definition template according to some embodiments.

FIG. 4 is a user interface including a pop-up window according to some embodiments.

FIG. 5 is a user interface including a non-exhaustive example of the primary table JOIN definition according to some embodiments.

FIG. 6 is a user interface including a non-exhaustive example of a secondary table JOIN definition according to some embodiments.

FIG. 7 is a user interface including a JOIN definition according to some embodiments.

FIG. 8 is a user interface including results from execution of the JOIN definition according to some embodiments.

FIG. 9 is a user interface including a syntax validation output according to some embodiments.

FIG. 10 is a user interface including a pop-up error notification according to some embodiments.

FIG. 11 is a user interface including non-exhaustive example of a CDS view with parameters table according to some embodiments.

FIG. 12 is a user interface including additional information for the CDS view with parameters according to some embodiments.

FIG. 13 is a user interface including a data definition according to some embodiments.

FIG. 14 is a user interface including a pop-up window to receive parameters for execution of the JOIN including the CDS view with parameters according to some embodiments.

FIG. 15 is a user interface including results from execution of the JOIN including the CDS view with parameters. according to some embodiments.

FIG. 16 is a block diagram of a cloud-based architecture according to some embodiments.

Throughout the drawings and the detailed description, unless otherwise described, the same drawing reference numerals will be understood to refer to the same elements, features and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown but is to be accorded the widest scope consistent with the principles and features disclosed herein. It should be appreciated that in development of any such actual implementation, as in any engineering or design project, numerous implementation-specific decisions must be made to achieve the developer's specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

One or more embodiments or elements thereof can be implemented in the form of a computer program product including a non-transitory computer readable storage medium with computer usable program code for performing the method steps indicated herein. Furthermore, one or more embodiments or elements thereof can be implemented in the form of a system (or apparatus) including a memory, and at least one processor that is coupled to the memory and operative to perform exemplary method steps. Yet further, in another aspect, one or more embodiments or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

As described above, an end user has functional expertise of the data in the database tables, and knows the data they want to analyze for a given scenario. However, creation of a report to give the end user the data they want to analyze conventionally requires coding knowledge (e.g., Structured Query Language (SQL)) and database knowledge (e.g., which data is in which table, data relationships between the tables and within the tables, etc.), that the end user is often lacking. For example, the data used in the reports may be spread across multiple tables in the database, and particular data from those tables is combined to create the report. Further, the complexity in creating the report increases with the number of tables being accessed to create the report and with the number of columns of data being accessed to create the report. Conventionally, to create a report, the end user sends a request to a report creation specialist (e.g., developer, IT analyst, etc.) and the specialist creates the report, which takes time. To create the report, the report creation specialist may write code to create a table join between the two or more tables. The table join is used to retrieve data from two or more tables based on the values of a common column, and helps to create a many-to-many relationship. A table join is implemented via a SQL JOIN clause. The JOIN clause is used to combine rows from two or more tables, based on a relationship between them (e.g., puts on the same row records with matching fields). There are several types of JOINs, including, but not limited to INNER, LEFT OUTER, RIGHT OUTER, FULL OUTER and CROSS. A LEFT OUTER JOIN returns all records from the left table, and the matched records from the right table. A RIGHT OUTER JOIN returns all records from the right table, and the matched records from the left table. A FULL OUTER JOIN returns all records when there is a match in either left or right table. An INNER JOIN joins left and right tables by predicates. In other words, only the rows that appear in both the left table and the right table meet the condition (e.g., the rows that are in the set intersection of the left and right tables) for being returned. A CROSS JOIN returns the Cartesian product of rows from the tables in the join. In other words, the CROSS JOIN combines each row from the first table with each row from the second table, to generate all combinations of records in the two or more tables. Often, the specialist also includes WHERE clauses to further filter the results of the JOIN, based on the end user request.

It is further noted that conventionally, in addition to table data, JOINs are applicable to Core Data Services (CDS) Views provided by the Core Data Services (CDS)® data modeling service from SAP®. A CDS View is a virtual data model that provides direct access to underlying tables of a database. The CDS view is not directly accessed by the end user, but rather the view is consumed by another program or tool. Key features of the CDS views include the ability to define views that access data from multiple tables, the use of annotations to provide additional information/metadata about the data model (e.g., data types, field labels, descriptions), and the ability to define associations between two or more entities in the data model (CDS view). CDS views are an enhancement of SQL, and INNER JOINS, LEFT OUTER JOINS, and RIGHT OUTER JOINS may be used within a CDS view. The JOIN may be created in a data definition for the CDS view. The data definition is used to define and consume data models. While JOINS may be used with standard CDS views, there is a type of CDS view-a CDS view with input parameters-that presents difficulties in executing a JOIN. A CDS view with input parameters allows the consumer of a view to provide additional information in order to retrieve data from this view. The CDS view in turn evaluates this information and takes it into account when calculating the results. Because the CDS view with parameters requires some input for those parameters from the user, to retrieve the data for the JOIN, conventionally, the specialist needed to first prompt the end user for the input parameters before the specialist could even write the JOIN as that input is included in the code used to perform the JOIN. This extra back-and-forth made the conventional process more time consuming. Additionally, given that CDS with parameters are written in ABAP code, the specialist also needs to be able to write ABAP code, requiring further specialization.

To address these problems, a data linking framework or system provides a user interface allowing an end-user to create JOINS on the fly without programming knowledge. Embodiments provide for the creation of a join definition and for the display of table join results without the necessity of creating reports or custom coding. By displaying the table join results without creating a report, there is no need to store reports, resulting in an increase in available storage space. The join definition is customizable by the end-user, and may include operators, totals, range selection options for secondary tables, and other options. Generating the table join results on-the-fly may also provide for the user to access complex information in a timely manner without programming effort. The join definition provided by one or more embodiments may also support the joining of CDS views with parameters, as well as the use of technical settings for each table (e.g., not only for the primary table). One or more embodiments provide for the combination of data from multiple tables and/or CDS views with parameters in a single display on-the-fly, and without generating a report. Embodiments further provide for syntax validation before the JOIN definition is executed. A benefit of the syntax validation described by embodiments is that it avoids the processing associated with executing an erroneous definition and it also avoids a data dump that may contain data from all of the table fields without any joins. Further, the data linking framework provides table join results on-the-fly (e.g., table join results checked in seconds), resulting in improved productivity. As non-exhaustive examples, improved productivity may be in the form of: time and financial gains afforded by end users checking relevant data on-the-fly without the need to have Information Technology (IT) departments, for example, build and deliver special reports; and avoiding the diversion of IT departments from other projects to build and deliver the special reports.

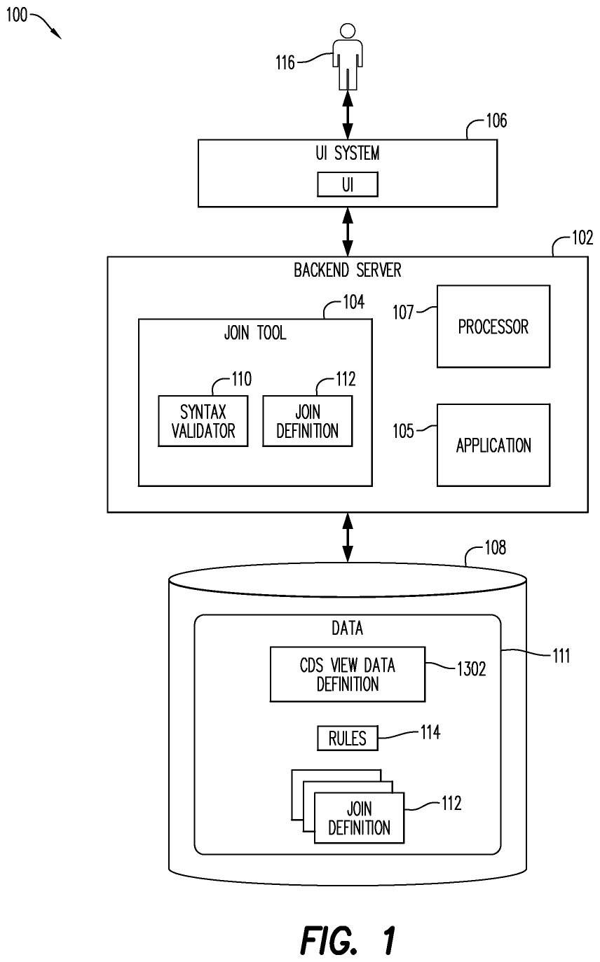

FIG. 1 is a high-level block diagram of a data linking and reporting framework or system architecture 100 according to some embodiments. The illustrated elements of system architecture 100 and of all other architectures depicted herein may be implemented using any suitable combination of computing hardware and/or software that is or becomes known. Such combinations may include one or more programmable processors (microprocessors, central processing units, microprocessor cores, execution threads), one or more non-transitory electronic storage media, and processor-executable program code. In some embodiments, two or more elements of system architecture 100 are implemented by a single computing device, and/or two or more elements of system architecture 100 are co-located. One or more elements of system architecture 100 may be implemented using cloud-based resources, and/or other systems which apportion computing resources elastically according to demand, need, price, and/or any other metric. One or more components may be implemented as a cloud service (e.g., Software-as-a-Service, Platform-as-a-Service).

System architecture 100 includes a back-end server 102 (including a JOIN tool 104, an application 105 and a processor 107), a user interface system 106, and a data store 108.

The back-end server 102 may comprise one or more servers, virtual machines, clusters of a container orchestration system, etc. The back-end server 102 may provide an operating system, services, I/O, storage, libraries, frameworks, etc. to applications and other components executing therein.

The JOIN tool 104 receives the data input to the user interfaces and generates the JOIN definition 112. The JOIN definition 112 includes at least two table names, representing respective tables, and conditions for the JOIN. The JOIN definition 112 may also include one or more JOIN options (e.g., an inner join option, a range of values, a grouping, a total, a sequence, a sort, a sort type, an aggregate, an output, filtering, etc.), and one or more JOIN conditions (e.g., a reference, a constant, a string, and a system variable). The JOIN definition 112 may be a query including a SELECT command and a WHERE clause, that when executed retrieves the specified data. The WHERE clause specifies criteria that field values must meet for the records that contain the values to be included in the output of the executed JOIN definition. In particular execution of the JOIN definition 112 includes checking the entries for each table included in the JOIN definition to identify the entries that meet the JOIN definition, generating an output table based on the selected output options and displaying the output table to the end user 116.

The JOIN tool 104 includes a syntax validator 110. The syntax validator 110 identifies errors in the JOIN definition 112 prior to execution of the query including the JOIN definition. The syntax validator 110 avoids the end user executing a query with errors and then discovering a data dump when the user begins to review the query output. The syntax validator 110 may be executed via user selection of a UI element, or automatically in response to saving the JOIN definition 112. Pursuant to embodiments, the syntax validator 110, during execution thereof, creates a SELECT statement for the data input to the JOIN tool 104 via the User Interface (UI) of UI system 106. A SELECT statement in Structured Query Language (SQL) is a command used to retrieve specific data from a database table (e.g., “query” a database table). The syntax validator 110 then executes the SELECT statement in the background. In a case of an error, execution of the SELECT statement will return an error notification. Execution of the SELECT statement may identify any errors that would prevent the JOIN definition from executing as desired (e.g., the syntax validator 110 prevents a data dump). The errors may be identified by the syntax validator based on one or more rules 114. As a non-exhaustive example, in a case the tables included in the JOIN definition require too much memory for the JOIN execution, instead of outputting a data dump, the syntax validator 110 outputs an error notification to the end user. The error notification may also include, via the syntax validator 110, possible solutions to resolve the error. Continuing with the non-exhaustive example, the error notification suggests the user include further filters in the data to limit the used memory. As another non-exhaustive example, the user selected a GROUP BY condition for the JOIN, and then forgot to include GROUP BY requirements (e.g., requirements for creating the GROUP BY are missing). In a case the JOIN was executed without the GROUP BY requirements, an OUTER JOIN on two large tables, for example, would result in a data dump. Embodiments avoid this data dump via execution of the syntax validator 110. The output (e.g., error notification or no error notification) of the syntax validator 110 is presented to user 116 via the UI system 106.

The UI system 106 may provide any suitable interfaces through which users 116 may communicate with the JOIN tool 104 or applications executing thereon. Non-exhaustive examples of users may be administrators/developers, end users, etc. Presentation of the user interface may comprise any degree or type of rendering, depending on the type of user interface code generated by UI system 106. The backend server 102 may include a Hyper Text Transfer Protocol (HTTP) interface supporting a transient request/response protocol over Transmission Control Protocol/Internet Protocol (TCP/IP), a WebSocket interface supporting non-transient full-duplex communications which implement the WebSocket protocol over a single TCP/IP connection, and/or an Open Data Protocol (OData) interface.

The backend server 102 may include one or more applications 105. Application 105 may comprise server-side executable program code (e.g., compiled code, scripts, etc.) executing within the backend server 102 to receive queries/requests from users 116 and provide results to users 116 based on the data of data store 108, and the output of the JOIN tool 104. As will be described further below, application 105 may comprise web applications which execute to provide desired functionality. User 116 instructs the system architecture 100, as is known, via application 105, for example, to create a JOIN definition or execute the JOIN definition to generate results and display the results without generating a report. The application 105 may comprise program code executable by a processor 107 to provide functions to end users 116 based on coded logic and on data 111 stored in data store 108. Data 111 may comprise tabular data stored in a columnar or row-based format, object data, CDS view data definitions, or any other type of data that is or becomes known. Data store 108 may comprise any suitable storage system such as a database system, which may be partially or fully remote from the back-end server 102, and may be distributed as is known in the art. Data store 108 (and other databases herein) represents any suitable combination of volatile (e.g., Random Access Memory) and non-volatile (e.g., fixed disk) memory used by the system to store the data.

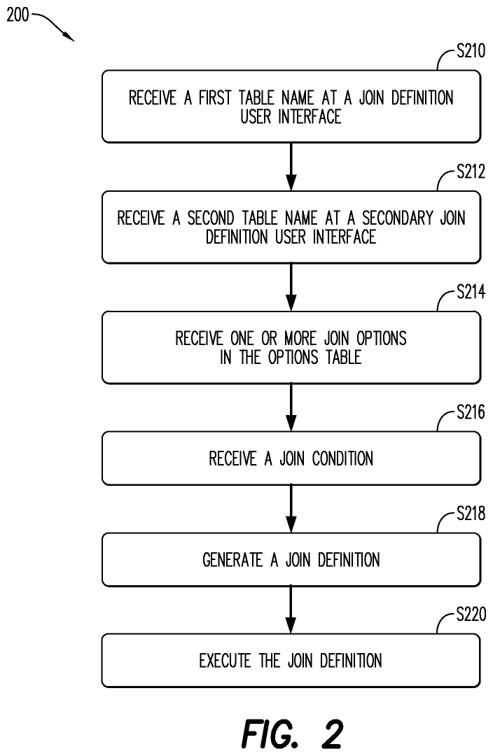

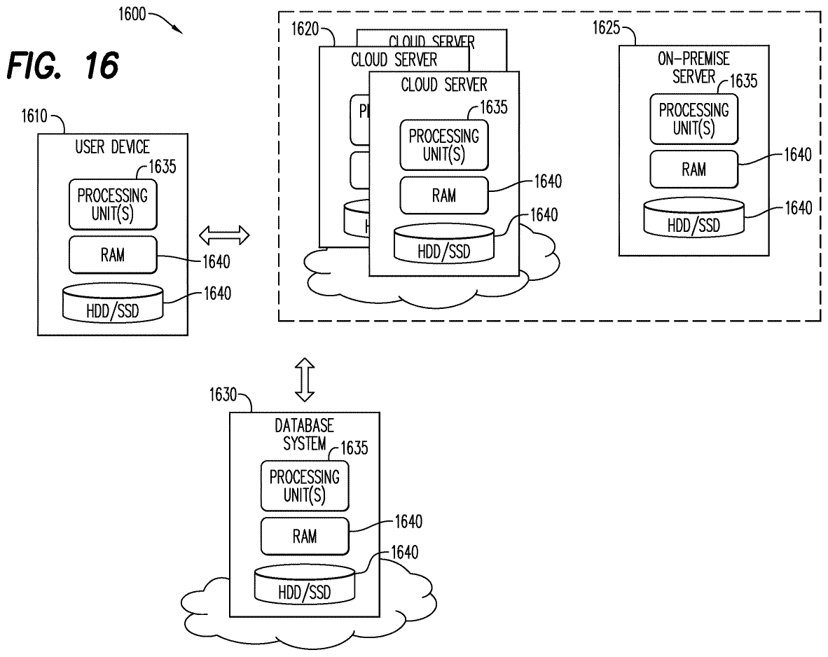

FIG. 2 illustrates a process 200 for generating and executing a JOIN definition in accordance with an example embodiment. The process 200, and other processes described herein, may be performed by a database node, a cloud platform, a server, a computing system (user device), a combination of devices/nodes, or the like, according to some embodiments. In one or more embodiments, the system architecture 100 may be conditioned to perform the process 200, and other processes described herein, such that a processing unit 1635 (FIG. 16) of the system architecture 100 is a special purpose element configured to perform operations not performable by a general-purpose computer or device.

All processes mentioned herein may be executed by various hardware elements and/or embodied in processor-executable program code read from one or more of non-transitory computer-readable media, such as a hard drive, a floppy disk, a CD-ROM, a DVD-ROM, a Flash drive, Flash memory, a magnetic tape, and solid state Random Access Memory (RAM) or Read Only Memory (ROM) storage units, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Prior to execution of the process 200, data 111 is generated and stored in the data store 108. In some instances, the data 111 is stored in tables.

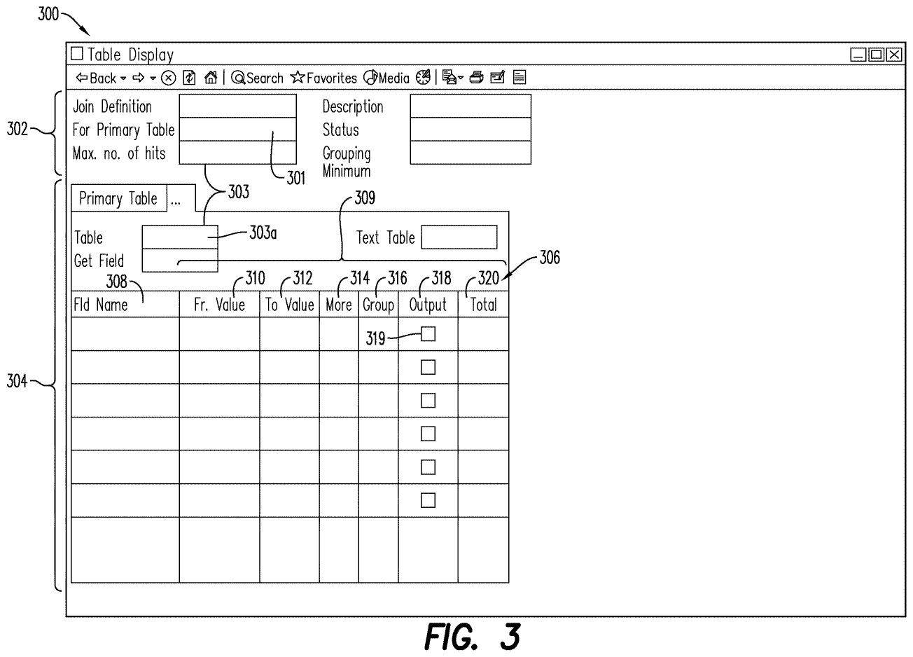

Initially, at S210 a first table name is received at a JOIN definition user interface 300 (FIG. 3). The JOIN definition user interface 300 may include primary table input area 302 with one or more elements 303. The elements 303 include, but are not limited to, Join Definition name, the primary table for which the JOIN is being defined, a maximum number of entries that may be returned, a description of the JOIN, a status of the JOIN, and a grouping minimum for the JOIN. In addition to the fields, the JOIN definition user interface 300 may also include one or more other elements 303 including, but not limited to a checkbox, drop down menu item, radio button, etc.).

The JOIN definition user interface 300 also includes a JOIN options area 304. The JOIN options area 304 includes text-entry elements 303 for the respective table-the primary table element in this case-a text table element, and a get field element. The JOIN options area 304 also includes a primary options table 306. The primary options table 306 may define fields for each of the entries. The fields, according to some embodiments, specify: a field name 308 and one or more JOIN options 309 that may be applied to the fields. The JOIN options 309 include, but are not limited to, a from value 310, a to value 312, a more 314, a group 316, an output 318 and a total 320. It is noted that other suitable JOIN options 309 may be included in the options table 306. The JOIN options 309 may act as filters on the JOIN. The field name 308 includes all of the fields included in the table for the table name received in the table element 303a in the JOIN options area 304. Pursuant to embodiments, receipt of the table name in the table element 303a results in the fields being populated in the column of the field name 308. As will be described further below, the From Value 310 and the To Value 312 relate to a selectable range for the field. The More 314 may include other JOIN options. The Group 316 provides for grouping any of the fields. The Output 318 includes an output indicator 319. Selection of the output indicator 319 denotes the respective field name (and values) will be displayed as part of the output resulting from execution of the JOIN definition. The Total 320 may display any calculation for that given field name.

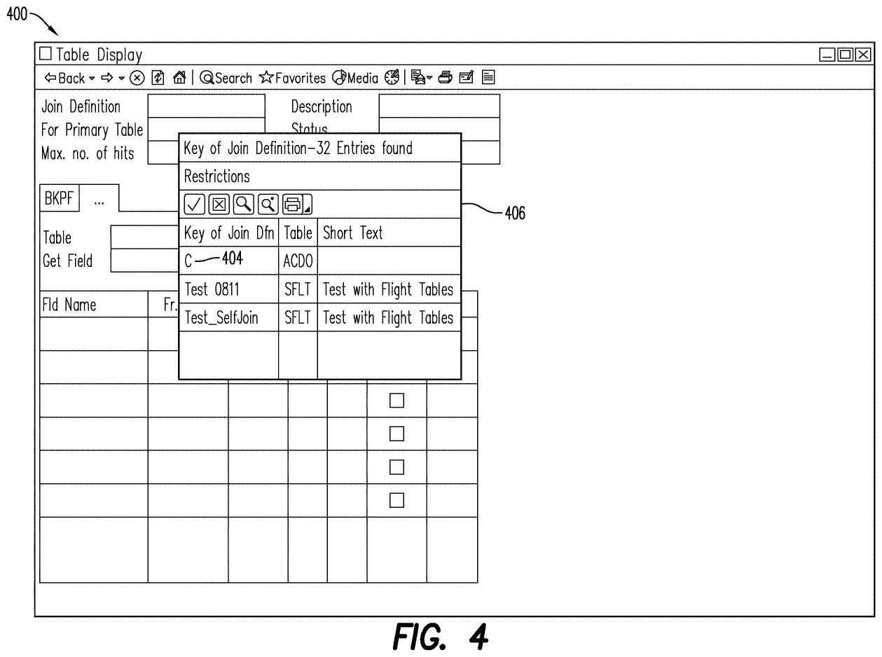

The first table name may be received directly in the Primary Table element 301 or may be received via selection of an entry 404 in a Saved JOIN definition table 406, shown in the user interface 400 of FIG. 4. The saved JOIN definitions may be edited as needed. The first received table name represents the primary table in the JOIN definition.

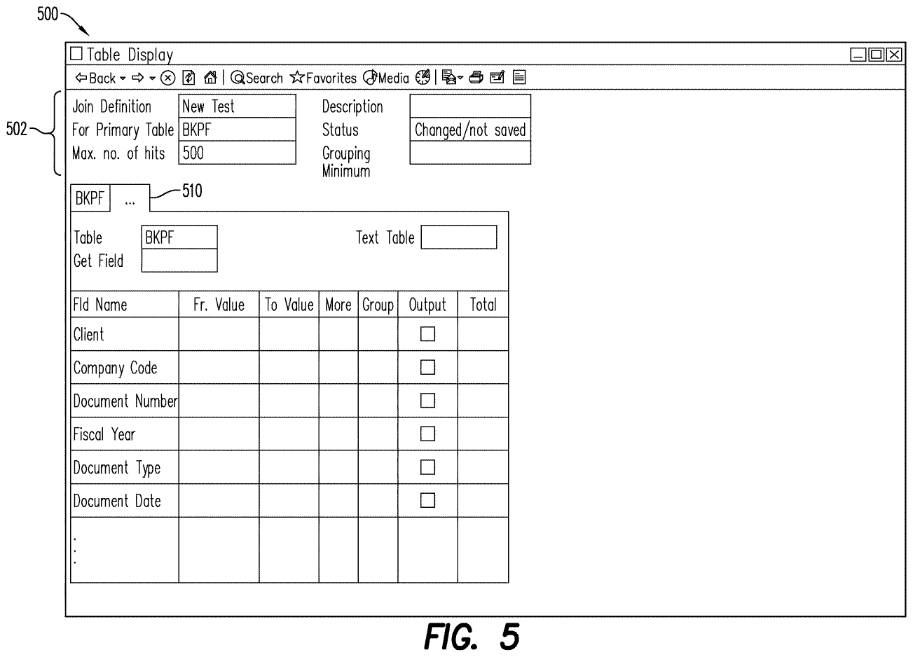

The primary JOIN definition user interface 500 shown in the non-exhaustive example of FIG. 5 includes the primary table “BKPF”. With a Maximum number of hits set to 500 and the status for the JOIN definition as Changed/Not saved. The fields included in the BKPF table have been populated in the Fld Name 308 column. The field names in this non-exhaustive example are Client, Company Code, Document Number, Fiscal Year, Document Type and Document Date. Other suitable fields may be included.

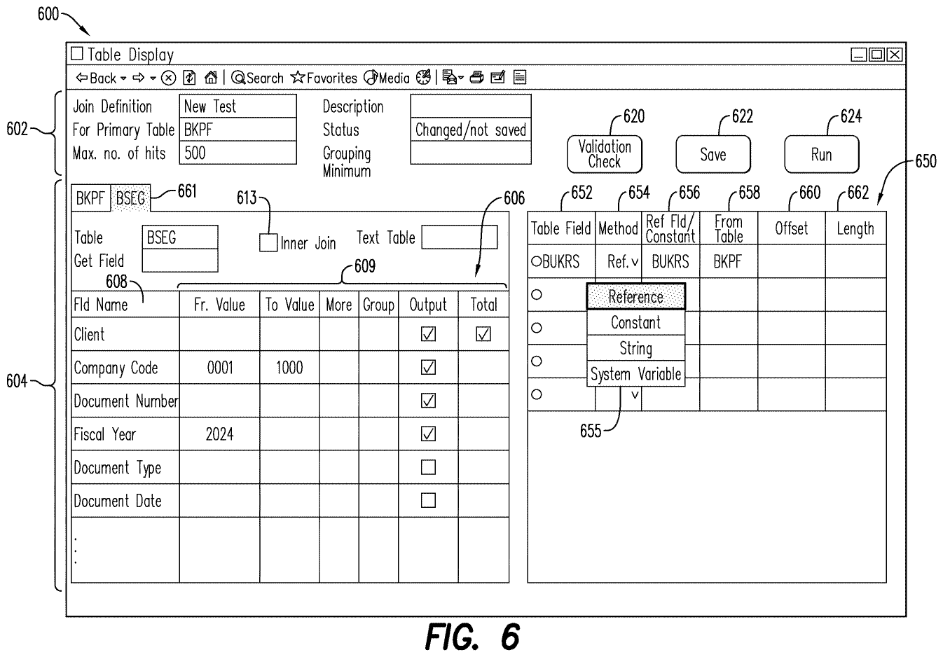

Turning back to the process 200, in S212, a second table name is received at a secondary table JOIN definition user interface 600 (FIG. 6). Pursuant to some embodiments, the end user 116 selected the blank tab 510 (FIG. 5) to generate the secondary table JOIN definition user interface 600. While the secondary table JOIN definition user interface 600 is similar to the primary JOIN definition user interface 500 of FIG. 5, the two user interfaces differ in some respects. For example, the primary JOIN definition user interface 500 and the secondary table JOIN definition user interface 600 have the same information in the table input area 502/602. A difference between the two interfaces 500/600 is that the table name in the JOIN options area 604 is for the secondary table name. Entry of the secondary table name may result in the population of the field names for the secondary options table 606 in the field name 608 column. Another difference is that the JOIN options area 604 of the secondary table JOIN definition user interface includes an Inner Join element 613. Pursuant to one or more embodiments, selection of the Inner Join element 613 results in an INNER JOIN to be performed between the instant table and the primary table during execution of the JOIN definition. In a case the Inner Join element 613 remains unselected, an OUTER JOIN is performed between the instant table and the primary table upon execution of the JOIN definition.

Continuing with the process 200, one or more JOIN options 609 are selected for entries in at least one of the primary options table 306 and the secondary options table 606 in S214.

In the non-exhaustive example shown in FIG. 6, the end user has selected several JOIN options 309 in the secondary options table 606. Here, the end user has selected a range for the Company Code field, by including a From Value of “0001” and a To Value of “1000” in the From Value 610 column and To Value 612 column respectively, limiting execution of the JOIN with the secondary table to the fields in the secondary table having these values. The end user has also input “2024” for the Fiscal Year field, limiting execution of the JOIN with the secondary table to the fields in the secondary table having this value. The end user has also selected to display results for the Client, Company Code, Document Number and Fiscal Year options, via selection of the checkbox element 619 in the Output 618. The end user has also requested a total of the number of clients in the second table via selection of a checkbox in the Total option element.

Then, in S216, a JOIN condition is received for at least one first field in the first table and at least one second field in the second table.

The secondary table JOIN definition user interface 600 further includes a JOIN condition table 650. The JOIN condition table 650 includes the conditions by which the JOIN of the tables will be executed. The JOIN condition table 650 may define fields for each of the entries. The JOIN condition fields may include, but are not limited to, a Table Field 652, Method 654, Ref field/Constant 656, From Table 658, Offset 660 and Length 662. The Table Field 652 indicates the field in the two tables that the JOIN is being performed on. In one or more embodiments, the field name in the secondary options table 606 is mapped to a field identifier in the data store. The field identifier may be the entry in the Table Field. As a non-exhaustive example, the field name “Company Code” has a field identifier of “BUKRS” and “BUKRS” is the entry in the Table Field 652 in the JOIN condition table 650. The Method 654 indicates types of relationships between the fields, and in particular the way in which the Table field and Reference field/Constant are being matched. The Reference field 656 refers to the field in the primary table or previous secondary table. It is noted that the JOIN definition may include more than two tables. As a non-exhaustive example, the JOIN definition may include three tables, and each of the tables included in the definition after the primary table may be referred to a “secondary” table. Each table included in the definition may be configured as part of the JOIN via a respective UI/tab. Alternatively, the tables may be referred to as secondary, tertiary, quaternary, etc. It is noted that in a case the same field is included in the three tables of the JOIN definition, only one entry may be included in the JOIN condition table 650 for the secondary or tertiary tab, as the three tables are joined and execution of the JOIN reviews all of the tables in the JOIN definition. As another option, an INNER JOIN may be used to combine results from all three tables without duplicating entries in the JOIN condition table. In some instances, the JOIN definition may include ten tables. The From Table 658 indicates the table the reference field/constant is from. The Offset 660 indicates the character difference being used to match the table field and the reference field in the case of a String method, as described further below. The Length 662 indicates the number of characters being used to match the table field and the reference field in the case of a String method.

The Method 654 may be one of Reference, String, Constant and System Variable. Other suitable methods maybe included. The method maybe selectable via a drop down menu 655 or other suitable element. Reference indicates the two fields (table field and reference field/constant) have to match exactly. String indicates the two fields (table field and reference field/constant) do not have to match exactly. With the String method, the user may enter values in the Offset 660. As a non-exhaustive example, the table field has a value of 2024, and the reference field/constant has a value of 24. Using the String method, the system searches for the 24 in the first string (table field string) based on an offset from character 3 to character 4, for example, which would indicate the 3^{rd} and 4^{th} characters in 2024 (e.g., “2” and “4”). With the Constant method, the table field value equals the value included in the reference field/constant. With the System Variable method, the value in the table field is equal to a system value. As a non-exhaustive example, the value in the table field is a date, and the system variable would be a system date, so the JOIN tool 104 is looking to match fields where the table value date is equal to the system date.

In the non-exhaustive example shown in FIG. 6 for the first entry, the Table Field 652 is “BUKRS”, the Method 654 is “Reference”, the Reference Field/Constant 656 “BUKRS” and the From Table 658 is “BKPF”, meaning the field on which the JOIN is being performed in the table in this tab 661 (denoted by the shading) is the BUKRS field (Table Field) (which is the identifier for the Company Code field) and the BUKRS field (Reference Field/Constant) (which is the identifier for the Company Code field) in BKPF table (From Table). In this case the From Table is the primary table, while in other cases, the From Table may be another secondary table. As a different non-exhaustive example, the table in this tab 661 may be a tertiary table and the From Table may be a secondary table.

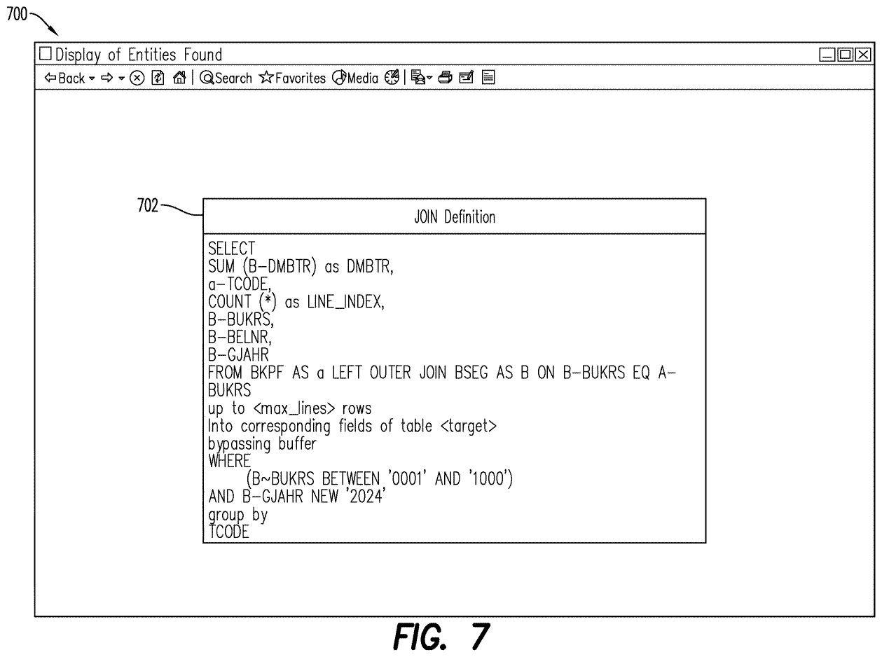

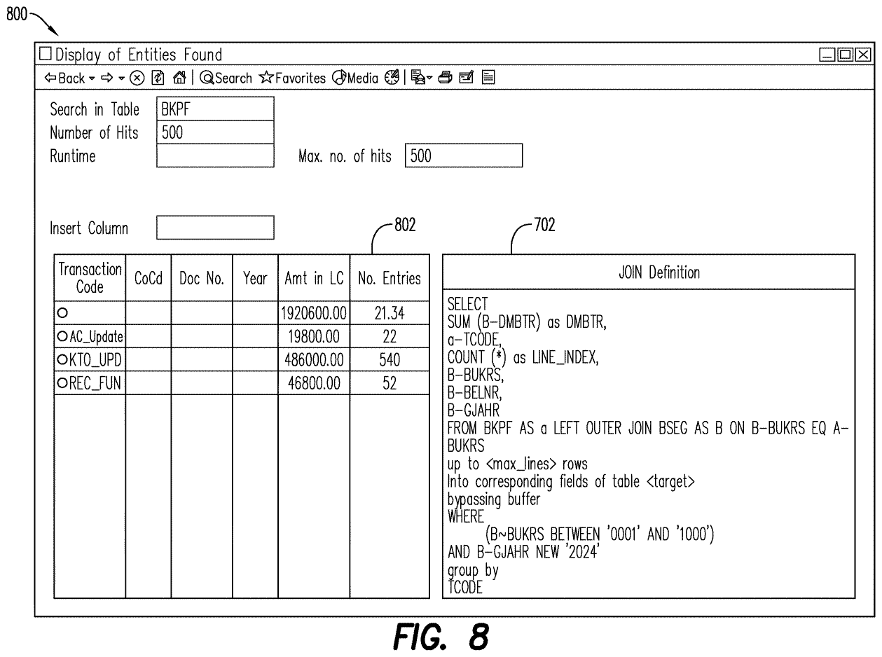

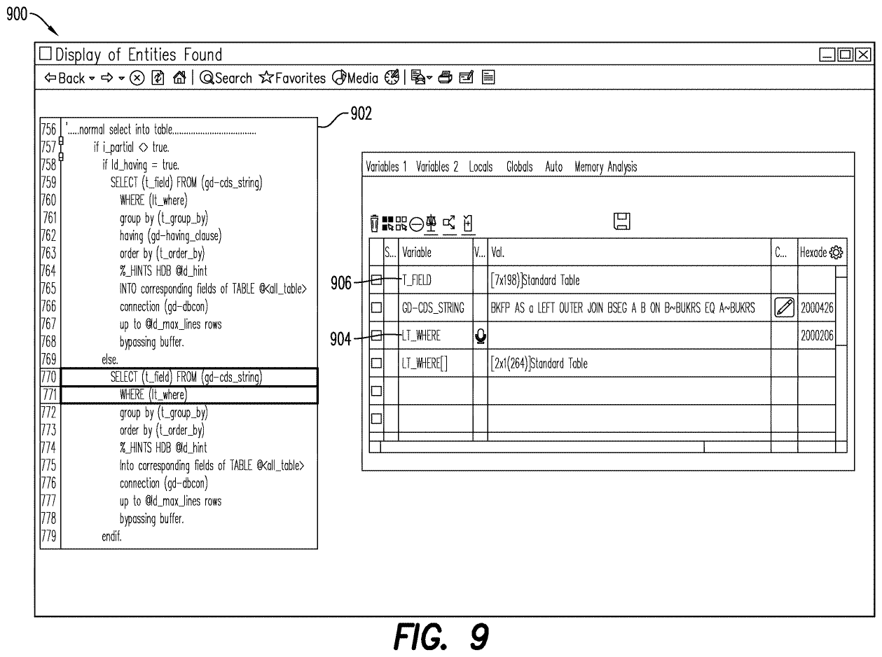

Turning back to the process 200, in S218 a JOIN definition 112 is generated. The JOIN definition 112 may be generated by the JOIN tool 104 in response to selection of one of a Validation Check element 620, a Save element 622, and a Run element 624. Selection of the Validation Check element 620 will be described further below, with respect to FIG. 9. Selection of the Save element 622 also saves the JOIN definition 112 to the data store 108. Selection of the Run element 624 also executes the JOIN definition 112, as described further below with respect to FIGS. 7 and 8.

FIG. 7 provides a JOIN definition user interface display 700 including a JOIN definition 702. Here, the JOIN definition is for the non-exhaustive example described in FIGS. 5-6. The JOIN definition 702 is in a SQL format. As described above, the JOIN definition 702 includes a SELECT command and a WHERE clause. The JOIN definition 702 is based on the input (e.g., primary and secondary tables, JOIN options, JOIN conditions, etc.) to the respective user interfaces. Here, the JOIN definition 702 is based on the input to the primary table per FIG. 5 and the secondary table per FIG. 6, JOIN options, and JOIN conditions. As part of the generation of the JOIN definition, JOIN tool 104 identifies the mapping of the field names in the primary JOIN definition UI 500 and the secondary JOIN definition UI 600 to field identifiers saved in the data store 108. As a non-exhaustive example, and as described above, the field name “Company Code” in the secondary JOIN definition UI 600 and the primary JOIN definition UI 500 maps to the field identifier “BUKRS”. Additionally, the field name “FISCAL YEAR” in the secondary JOIN definition UI 600 maps to the field identifier GJAHR. Here, the FISCAL YEAR field name has a constant of “2024” as a “From Value”. The JOIN definition 702 described in the non-exhaustive example of FIG. 7 includes the COUNT of entries per the selected ”Total“ JOIN option 609 in the secondary options table 606. The JOIN definition 702 also specifies the output of data in three fields of the secondary table (denoted by ”B“)-B-BUKRS, B_BELNR, and B-GJAHR from the BKPF table as a left outer JOIN with the BSEG table with the join condition of the B-BUKRS from secondary table (B) equaling (based on the selected Reference method) the entry in the BUKRS field of the primary table (denoted by “A”). It is noted that an end-user may want to see fields in the output but not have these fields included in the JOIN condition. To accomplish this, the end-user selects the output element option for those fields. The JOIN definition 702 further specifies the selected options (e.g., filters) applied to the results of the JOIN via the “WHERE” clause. Here, the applied selection options include B-BUKRS (Company Code) being between ‘0001’ and ‘1000” and B-GJAHR (FISCAL YEAR) being “2024”.

Turning back to the process 200, in S220 the JOIN definition 112 is executed. The JOIN definition 112 may be executed in response to selection of the Run element 624. As described above, execution of the JOIN definition 112 retrieves, via query, specific data from the selected database tables. The JOIN results table 802 may be displayed in a Display of Entities Found User Interface 800 (FIG. 8). In one or more embodiments, the Display of Entities Found UI 800 may also display the executed JOIN definition 702. The JOIN results in the table 802 are displayed on the UI without having to generate a report of the results, thereby avoiding consumption of the resources used in the report generation process, as well as avoiding consumption of storage resources for storing reports.

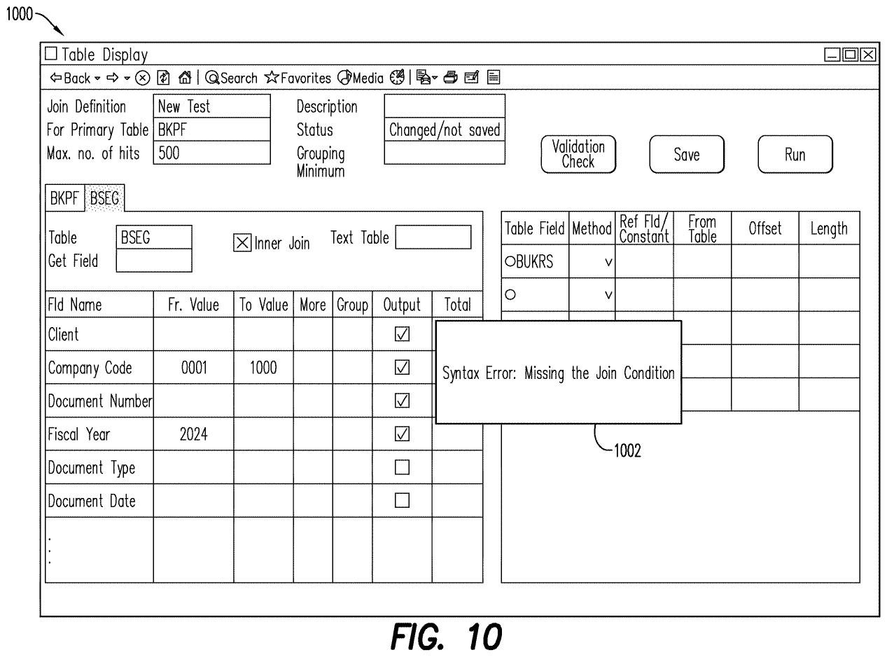

As described above, selection of the Validation Check element 620 in FIG. 6 executes the syntax validator 110. As described above, selection of the Validation Check element 620 results in the generation of the JOIN definition, which is then transmitted to the syntax validator 110. The syntax validator 110 may act as a debugger and executes the received JOIN definition under controlled conditions. In other embodiments, the syntax validator 110 creates a SELECT statement 902 for the data input to the JOIN tool 104 via the UI, as shown in the debugger user interface 900 of FIG. 9, without generating the JOIN definition, and executes the SELECT statement under controlled conditions. The syntax validator 110 also tests the JOIN options reflected in the JOIN WHERE condition (lt_where) 904 and output fields selection 906 reflected in the JOIN output fields (t_field) 906 in the code displayed by the syntax validator. In a case of an error, the syntax validator 110 returns an error notification 1002, shown in the user interface 1000 of FIG. 10. Execution of the syntax validator 110 may identify any errors that would prevent the JOIN definition from executing as desired (e.g., the syntax validator 110 prevents a data dump). The errors may be identified by the syntax validator 110 based on one or more rules 114. As a non-exhaustive example shown in FIG. 10, the user indicated the JOIN should be on the field BUKRS in the secondary table, and then forgot to include JOIN conditions (e.g., conditions for defining how the tables are joined are missing) in the JOIN condition table. In a case the JOIN was executed without the JOIN conditions, an OUTER JOIN on two large tables, for example, would result in a data dump. The output (e.g., error notification 1002 or no error notification) of the syntax validator 110 is presented to user 116 via the UI system 106.

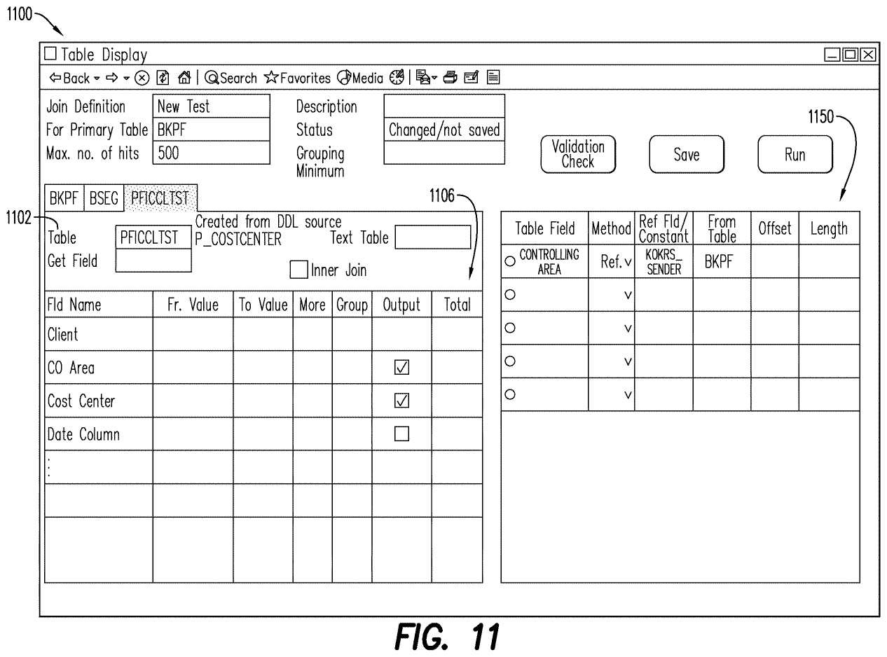

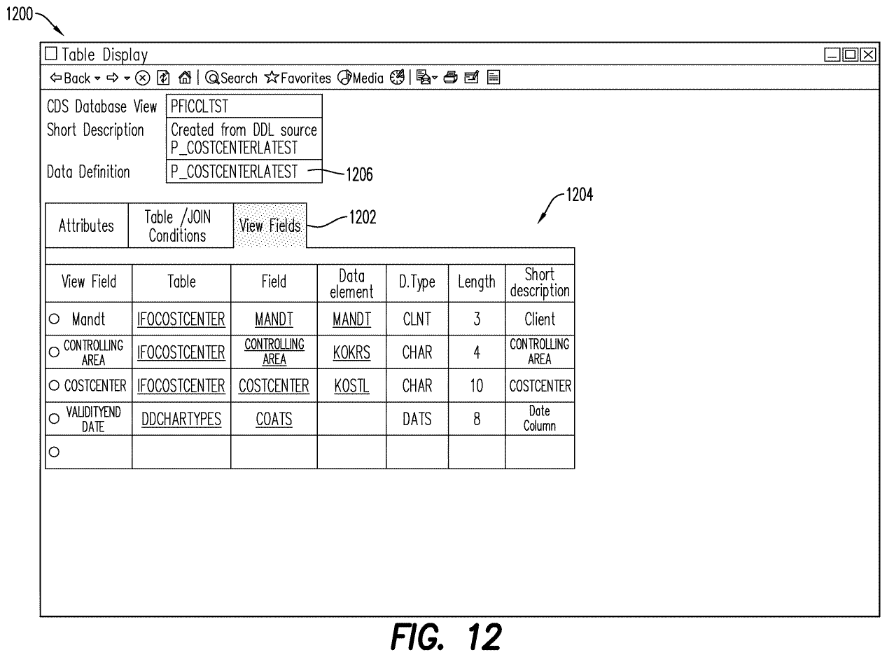

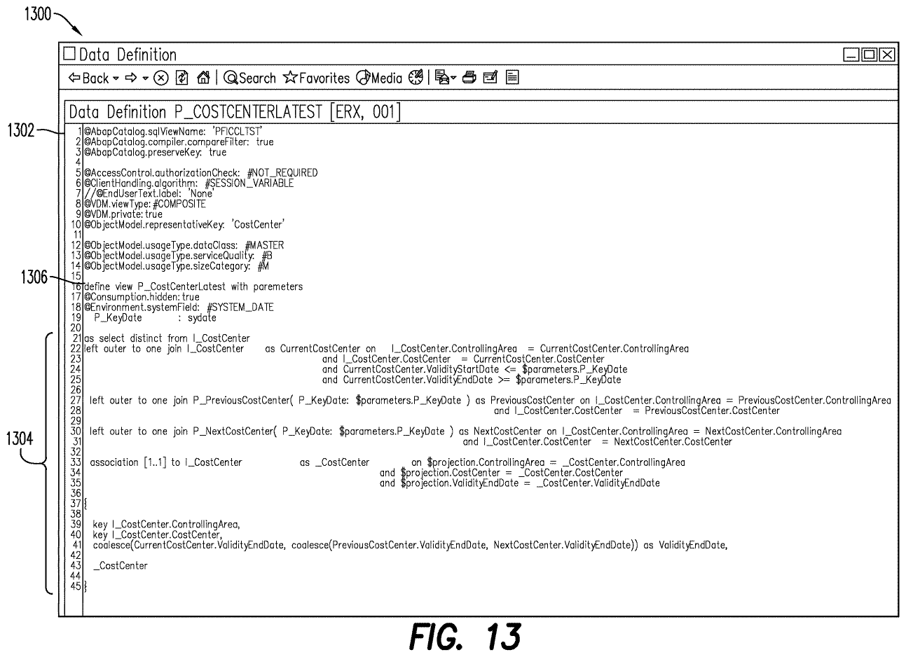

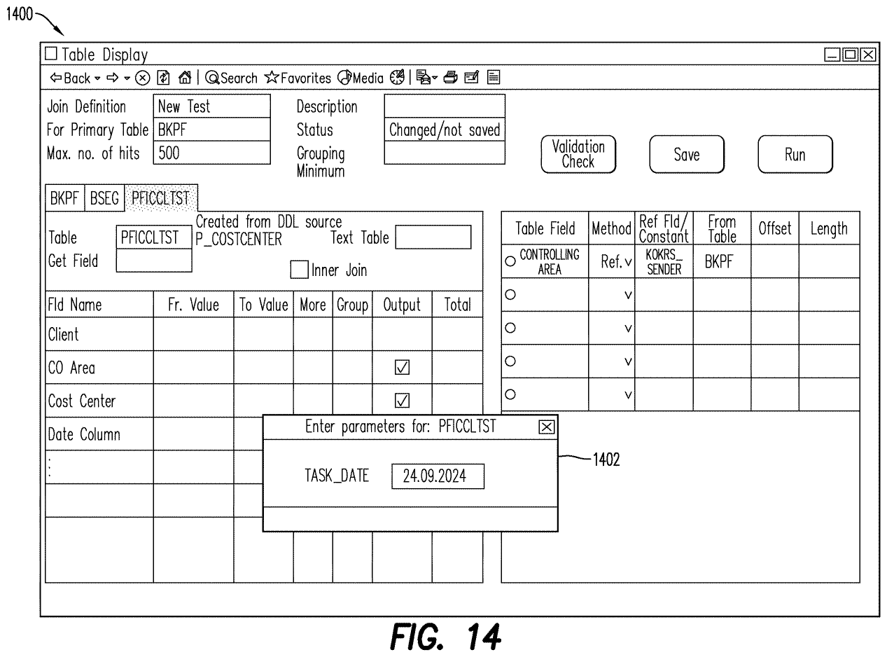

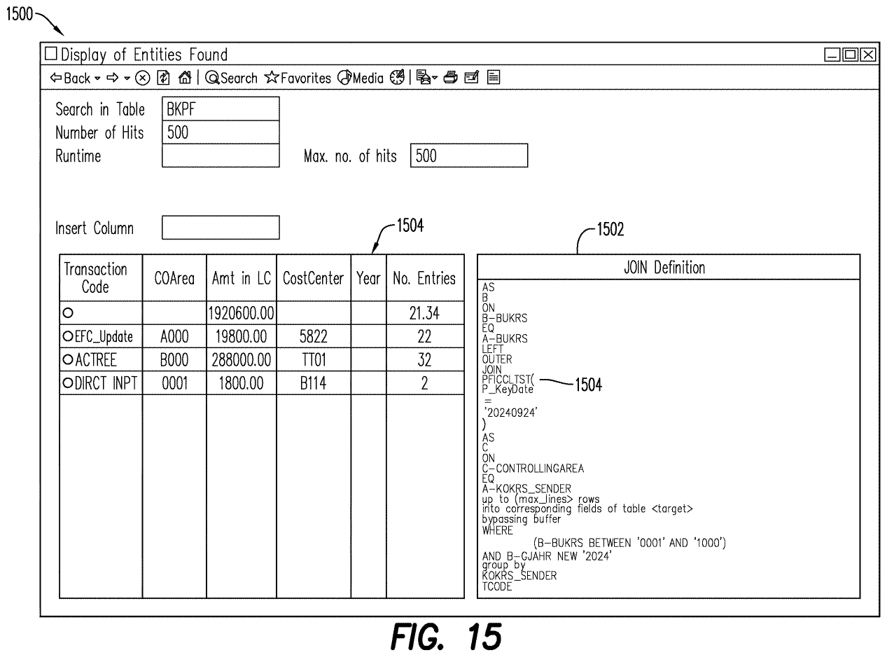

FIG. 11 is a tertiary table JOIN definition user interface 1100 including receipt of a third table name. The tertiary table JOIN definition UI 1100 is generated in the same way as the secondary table JOIN definition UI 600. Like the secondary table JOIN definition UI 600, the tertiary table JOIN definition UI 1100 includes an options table 1106 and a condition table 1150 to receive options and conditions, respectively, as described above with respect to FIG. 6. Here, however, the tertiary table is a CDS view with parameters, with the name “PFICCLTST”. As described above, the CDS view is not directly accessed by the user. The JOIN for the CDS view with parameters may be created in a data definition for the CDS view (FIG. 13). The user may, in one or more embodiments, select the Table element 1102 in the tertiary table JOIN definition UI 1100 to view additional CDS view with parameter information, as shown in the CDS view with parameter UI 1200 of FIG. 12. The “View Fields” tab 1202 of the is selected herein as indicated by the shading and includes a View Fields table 1204 that defines fields for each of the entries. The fields are View Field, Table, Data Element, D. Type, Length and Short Description. Other suitable fields may be used. The View Field describes the table fields to be used in the view. The Table describes the underlying table accessed for the CDS view. The Field describes the field in the underlying table. The D. Type indicates the type of data in the field (e.g., character, date, etc.). Length describes the number of characters of the values. Short description describes the field with a condensed description. The entries in the View Fields table 1204 are populated based on the data definition. Selection of other tabs (e.g., attributes table/JOIN conditions), results in the display of other elements defining the CDS view with parameters. For example, selection of the table/JOIN conditions tab returns the user to the tertiary table JOIN definition UI 1100. Pursuant to some embodiments, the value in the data definition field is a link 1206 to the data definition. Selection of the data definition link displays in a user interface 1300 (FIG. 13) a data definition for the CDS view with parameters 1302. The JOIN definition for the tertiary table is created in the data definition 1302, as shown herein. In addition to the JOIN conditions 1304, the data definition 1302 also includes the parameter 1306 for which input will be needed during execution of the JOIN. As described above, while CDS views with parameters are not actual tables, the JOIN tool displays the CDS view in a table-format to facilitate use and understanding by the end-user. Further, a pop-up window 1402 (FIG. 14) including an input area is displayed during execution of the JOIN with a CDS view with parameters for the end user to enter the parameter values. The parameters may be initial values that are input in order to access the CDS view values. In the non-exhaustive example shown herein, the input parameter value is the date. In a case the date is not provided when the end-user wants to display the CDS view, the content of the CDS view will not be displayed. These parameters, fields and other JOIN conditions are generated as a JOIN definition 1502 (FIG. 15) in SQL format, as described above in S218 of FIG. 2. The JOIN definition 1502 of FIG. 15 displays the fields 1504 of the CDS view with parameters that are accessed to retrieve data. Here, the field is the P_KeyDate. Then, to execute the JOIN with the CDS view with parameters, the JOIN tool 104 searches each table that is part of the JOIN definition to determine whether they are CDS views, and if they are CDS views, to determine whether they have parameters. In a case they have parameters, the JOIN tool 104 displays the pop-up window 1402 for the end-user to enter the parameter value in order to be able to access the CDS view data. Then, after the parameter value is received, the JOIN tool 104 may join the data in the tables per the JOIN definition. Here, the Display of Entries found UI 1500 of FIG. 15 includes a results table 120 in addition to the JOIN definition 1502.

FIG. 16 illustrates a cloud-based database deployment 1600 according to some embodiments. The illustrated components may reside in one or more public clouds providing self-service and immediate provisioning, autoscaling, security, compliance and identity management features.

User device 1610 may interact with applications executing on one of the cloud application server 1620 or the on-premise application server 1625, for example via a Web Browser executing on user device 1610, in order to create, read, update and delete data managed by database system 1630. Database system 1630 may store data as described herein and may execute processes as described herein to cause the execution of the JOIN tool 104 for use with the user device 1610. Cloud application server 1620 and database system 1630 may comprise cloud-based compute resources, such as virtual machines, allocated by a public cloud provider. As such, cloud application server 1620 and database system 1630 may be subjected to demand-based resource elasticity. Each of the user device 1610, cloud server 1620, on-premise application server 1625, and database system 1630 may include a processing unit 1635 that may include one or more processing devices each including one or more processing cores. In some examples, the processing unit 1635 is a multicore processor or a plurality of multicore processors. Also, the processing unit 1635 may be fixed or it may be reconfigurable. The processing unit 1635 may control the components of any of the user device 1610, cloud server 1620, on-premise application server 1625, and database system 1630. The storage devices 1640 may not be limited to a particular storage device and may include any known memory device such as RAM, ROM, hard disk, and the like, and may or may not be included within a database system, a cloud environment, a web server or the like. The storage device 1640 may store software modules or other instructions/executable code which can be executed by the processing unit 1635 to perform the method shown in FIG. 2. According to various embodiments, the storage device 1640 may include a data store having a plurality of tables, records, partitions and sub-partitions. The storage device 1640 may be used to store database records, documents, entries, and the like.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, external drive, semiconductor memory such as read-only memory (ROM), random-access memory (RAM), and/or any other non-transitory transmitting and/or receiving medium such as the Internet, cloud storage, the Internet of Things (IOT), or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

1. A system comprising:
a memory storing program code; and
one or more processing units to execute the program code to cause the system to:
receive a first table name, wherein the first table name represents a first table including one or more first fields;
receive a second table name, wherein the second table name represents a second table including one or more second fields and the second table represents a Core Data Services (CDS) view with parameters, wherein CDS is a data modeling service;
receive one or more join options for at least one of the first table and the second table;
receive a join condition for at least one first field and at least one second field;
generate a join definition based on the received first table name, the received second table name, the received one or more join options and the received join condition;
and
execute the join definition.

2. The system of claim 1, wherein the first table name, the second table name and the join condition are received in a respective element of a user interface.

3. The system of claim 2, wherein the first table name is received via selection from a table name menu.

4. (canceled)

5. The system of claim 1, wherein the CDS view with parameters is defined by a data definition.

6. The system of claim 1, further comprising program code to cause the system to:
receive a CDS view parameter prior to execution of the JOIN definition, wherein the CDS view parameter provides access to CDS view content.

7. The system of claim 1, wherein the join options are: an inner join option, a range of values, a grouping, an output, a total, a sequence, a sort, a sort type, and an aggregate.

8. The system of claim 1, wherein the join condition is one of: a reference, a constant, a string, and a system variable.

9. The system of claim 1, further comprising program code to cause the system to:
execute a syntax validation process for the generated JOIN definition prior to execution of the JOIN definition.

10. The system of claim 9, wherein the syntax validation includes execution of a SELECT statement including the received first table name, the received second table name, the received JOIN options, and the received join condition.

11. The system of claim 9, further comprising program code to cause the system to:
output a proposed solution in a case the syntax validation process determines the generated JOIN definition includes one or more errors.

12. The system of claim 1, further comprising program code to cause the system to:
receive a third table name, wherein the third table name represents a third table including one or more third fields;
receive one or more JOIN options for the third table;
receive a join condition for at least one third field and at least one of: at least one first field and at least one second field;
generate the JOIN definition including the join condition; and
execute the JOIN definition.

13. A computer-implemented method comprising:
receiving a first table name in a first table name field of a user interface, wherein the first table name represents a first table including one or more first fields;
receiving a second table name in a second table name field of the user interface, wherein the second table name represents a second table including one or more second fields and the second table represents a Core Data Services (CDS) view with parameters, and wherein CDS is a data modeling service;
receiving, in the user interface, one or more join options for at least one of the first table and the second table;
receiving a join condition for at least one first field and at least one second field in a join condition field of the user interface;
generating a JOIN definition based on the received first table name, the received second table name, the received one or more join options and the received join condition; and
executing the JOIN definition.

14. (canceled)

15. The method of claim 13, further comprising:
receiving a CDS view parameter prior to execution of the JOIN definition, wherein the CDS view parameter provides access to CDS view content.

16. The method of claim 13, further comprising:
executing a syntax validation process for the generated JOIN definition prior to execution of the JOIN definition.

17. The method of claim 13, further comprising:
receiving a third table name, wherein the third table name represents a third table including one or more third fields;
receiving one or more join options for the third table;
receiving a join condition for at least one third field and at least one of: at least one first field and at least one second field;
generating the JOIN definition including the join condition; and
executing the JOIN definition.

18. One or more non-transitory, computer-readable medium storing instructions, that, when executed by a computing system, cause the computing system to perform operations comprising:
receiving a first table name in a first table name field of a user interface, wherein the first table name represents a first table including one or more first fields;
receiving a second table name in a second table name field of the user interface, wherein the second table name represents a second table including one or more second fields and the second table represents a Core Data Services (CDS) view with parameters wherein CDS is a data modeling service;
receiving, in the user interface, one or more join options for at least one of the first table and the second table;
receiving a join condition for at least one first field and at least one second field in a join condition field of the user interface;
generating a JOIN definition based on the received first table name, the received second table name, the received one or more join options and the received join condition; and
executing the join definition.

19. The media of claim 18, further comprising:
receiving a CDS view parameter prior to execution of the JOIN definition, wherein the CDS view parameter provides access to CDS view content.

20. The media of claim 18, further comprising:
receiving a third table name, wherein the third table name represents a third table including one or more third fields;
receiving one or more join options for the third table;
receiving a join condition for at least one third field and at least one of: at least one first field and at least one second field;
generating the JOIN definition including the join condition; and
executing the JOIN definition.
